(19) United States
(12) Patent Application Publication
(10) Pub. No.: US 2014/0095283 A1
(43) Pub. Date: Apr. 3, 2014

(54) REFERRAL BASED MARKETING SYSTEM

(71) Applicant: Scott Wilson Design, Ltd., Minimal Studios, Chicago, IL (US)

(72) Inventors: Scott H. Wilson, Chicago, IL (US); Chris Sherrill, Chicago, IL (US); Dennis Matthew Puhalla, Chicago, IL (US); Scott Schenone, Chicago, IL (US)

(21) Appl. No.: 14/041,630

(22) Filed: Sep. 30, 2013

Related U.S. Application Data
(60) Provisional application No. 61/708,242, filed on Oct. 1, 2012.

(51) Int. Cl. G06Q 30/02

(52) U.S. Cl. CPC G06Q 30/0214
USPC 705/14.16

(57) ABSTRACT

Systems and methods are provided for managing referrals for referred products, including providing rewards in response to accepting a purchase transaction request for the referred product, executing a purchase transaction related to the request, and receiving referring consumer identification data. Referring consumer identification data may be transmitted to the first electronic device after an account is created. A product data request relating to a referred product may be received from a first electronic device associated with a referring consumer, and the product data may be transmitted to the first electronic device. A purchase transaction request for the referred product and the referring consumer identification data may be received from a second electronic device associated with a referred consumer. A reward may be provided to the referring consumer in response to executing the purchase transaction, and may be based on the purchase transaction request. A purchase reward for the referred product may also be provided to the referred consumer.

### CROSS-REFERENCE TO RELATED APPLICATIONS

This non-provisional patent application claims priority to U.S. Provisional Patent App. No. 61/708,242 filed on Oct. 1, 2012. The provisional application is incorporated herein by reference in its entirety.

### TECHNICAL FIELD

This application generally relates to the management of a product referral. In particular, the application relates to a system for promoting personal product referrals from customers and providing rewards in response to the acceptance of a purchase transaction request for a referred product, execution of the purchase transaction related to the purchase transaction request, and receiving referring consumer identification data.

### BACKGROUND OF THE INVENTION

Retailers may utilize various techniques to market their goods and services to consumers, such as advertising in publications and on websites. Such marketing may include testimonials and endorsements by consumers who have already bought and used the particular goods and services of a retailer. Prospective consumers may be more likely to be responsive to this type of marketing. In particular, an endorsement of particular goods and services by a person trusted by a prospective consumer may influence and induce the prospective consumer to become interested in and perhaps purchase the retailer's goods and services. A prospective consumer may find this type of personal endorsement to be more credible than other types of marketing. This type of personal endorsement may also be known as word-of-mouth endorsement.

Although word-of-mouth endorsement may be effective, the nature of such types of endorsements may make it difficult for retailers to utilize because they are not directly controllable by the retailer. In particular, while an existing consumer of the retailer's goods and services may be satisfied with the goods and services and may even be willing to recommend the goods and services, the existing consumer generally has little incentive to do so. Moreover, the existing consumer may not discuss, endorse, or recommend the goods and services to another person unless a related topic is being discussed, or if the existing consumer is specifically asked about the goods and services. The existing consumer may also not have a convenient way to recommend the goods and services. Moreover, even if an existing consumer recommends a retailer's goods and services to a prospective consumer, the prospective consumer may not immediately be able to act upon the recommendation. In a fast-paced world, the prospective consumer may move on to other activities and forget about the recommended goods and services before having a chance to purchase the goods and services.

In other cases, a prospective consumer may witness or see a friend or colleague with a consumer good that they find to be of interest and inquire about to the friend of colleague. Though certain information may be conveyed about the product at that point, it may be some time before the prospective consumer has an opportunity to react to the information and convert it into a purchase. What is needed is a tool that can quickly provide digital assistance to the prospective consumer, including information about the product and a link to effect an immediate purchase. This provides a method for converting a product inquiry into a product purchase before the opportunity passes. Moreover, there is a need to track a referral so as to provide a reward or incentive to use the system to provide the digital assistance.

Furthermore, customer acquisition costs relating to offline and online marketing can be significant. In order to be profitable, customer acquisition costs for a retailer should not exceed the average lifetime value of a consumer. Even if a retailer commits to such marketing, advertising from retailers is not generally trusted by consumers. For example, digital advertising, such as banner ads, mobile ads, and the like, are not trusted by the vast majority of consumers.

Accordingly, there is an opportunity for systems and methods that address these concerns. More particularly, there is an opportunity for systems and methods that manage the referral for a referred product, including providing rewards in response to the acceptance of a purchase transaction request for the referred product, execution of the purchase transaction related to the purchase transaction request, and receiving referring consumer identification data.

### SUMMARY OF THE INVENTION

Systems and methods are disclosed for managing the referral for a referred product, including providing rewards in response to the acceptance of a purchase transaction request for the referred product, execution of the purchase transaction related to the purchase transaction request, and receiving referring consumer identification data. According to one embodiment, a method for managing a referral for a referred product may include transmitting referring consumer identification data that uniquely identifies a referring consumer to a first electronic device associated with a referring consumer. A request for product data relating to a referred product may be received from the first electronic device. The product data may be retrieved from a database and transmitted to the first electronic device, in response to receiving the request. A purchase transaction request for the referred product and the referring consumer identification data may be received from a second electronic device associated with a referred consumer. The purchase transaction request for the referred product may be accepted, and the purchase transaction related to the purchase transaction request may be executed. Reward data representing a reward may be provided to an account of the referring consumer in response to the execution of the purchase transaction. The reward may be based on the purchase transaction request and the account of the referring consumer may be identified from the referring consumer identification data.

According to another embodiment, a system for managing a referral for a referred product may include a processor in communication with a network and a memory in communication with the processor. The memory may include a product database with product data relating to the referred product. The memory may also include an account management engine for transmitting referring consumer identification data that uniquely identifies a referring consumer to a first electronic device associated with a referring consumer. The memory may further include a referral generation engine for receiving a request that is for product data relating to a referred product from the first electronic device. The referral generation engine may also be for retrieving the product data from the product database and transmitting the product data to the first electronic device, in response to receiving the request. The memory may further include a purchase and reward management engine for receiving a purchase transaction request for the referred product and the referring consumer identification data from a second electronic device associated with a referred consumer. The purchase and reward management engine may accept the purchase transaction request and execute the purchase transaction related to the purchase transaction request. The purchase and reward management engine may also be for providing reward data representing a reward to an account of the referring consumer in response to executing the purchase transaction. The reward may be based on the purchase transaction request and the account may be identified from the referring consumer identification data.

In accordance with the systems and methods discussed herein, a referred consumer may have viewed a referred product on an electronic device of a referring consumer. The referring consumer (also referred to herein as the customer sales rep) may recommend the referred product to the referred consumer (also referred to herein as the potential consumer or target consumer) by instantly supplying product data for the referred product to the referred consumer. The referred consumer may also receive referring consumer identification data that uniquely identifies the referring consumer. The referred consumer may transmit a purchase transaction request for a referred product and the referring consumer identification data. Based on the referring consumer identification data and execution of the purchase transaction, a reward, such as a discount or commission, may be provided to an account of the referring consumer. A purchase reward may also be provided to the referred consumer making the purchase transaction request, such as a discount off of a purchase price of the referred product. Accordingly, a referring consumer may have an incentive to recommend products of the retailer in a convenient way. Furthermore, the referred consumer may immediately be able to act upon the recommendation of the referring consumer when the product data for the referred product is received by the referred consumer, while the “wow moment” of the recommendation is still fresh in the mind of the referred consumer and the opportunity to convert a sale is maximized.

For the retailer, customer acquisition costs may be significantly reduced. While consumers are rewarded for their normal behavior that the consumers would do anyway, e.g., speaking to friends and recommending products, the cost to the retailer is less than traditional offline and online marketing techniques. Moreover, the word-of-mouth endorsement of the referred product is more likely to be trusted by a referred consumer than other marketing techniques. The referring consumers, who may be existing customers of a retailer, are generally a retailer's most effective distribution channel. It should be appreciated that other benefits and efficiencies are envisioned.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a block diagram illustrating a system for managing a referral of a referred product.

FIG. 2 is a block diagram of one form of a computer or server of FIG. 1, having a memory element with a computer readable medium for implementing the system of FIG. 1.

FIG. 3 is a flow diagram illustrating operations for managing a referral of a referred product using the system of FIG. 1

FIG. 4 is a block diagram illustrating elements of an alternative embodiment of a referral system.

FIG. 5 is a flow chart illustrating steps in a referral process.

FIGS. 6-11 are screen shots of an exemplary application operating within the referral system of FIGS. 4 and 5.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way as to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements or steps may be labeled with the same reference numerals. However, sometimes these elements or steps may be labeled with differing numbers, such as, for example, in cases where such labeling facilitates a more clear description. Such labeling and drawing practices do not necessarily implicate an underlying substantive purpose. As stated above, the present specification is intended to be taken as a whole and interpreted in accordance with the principles of the present invention as taught herein and understood to one of ordinary skill in the art.

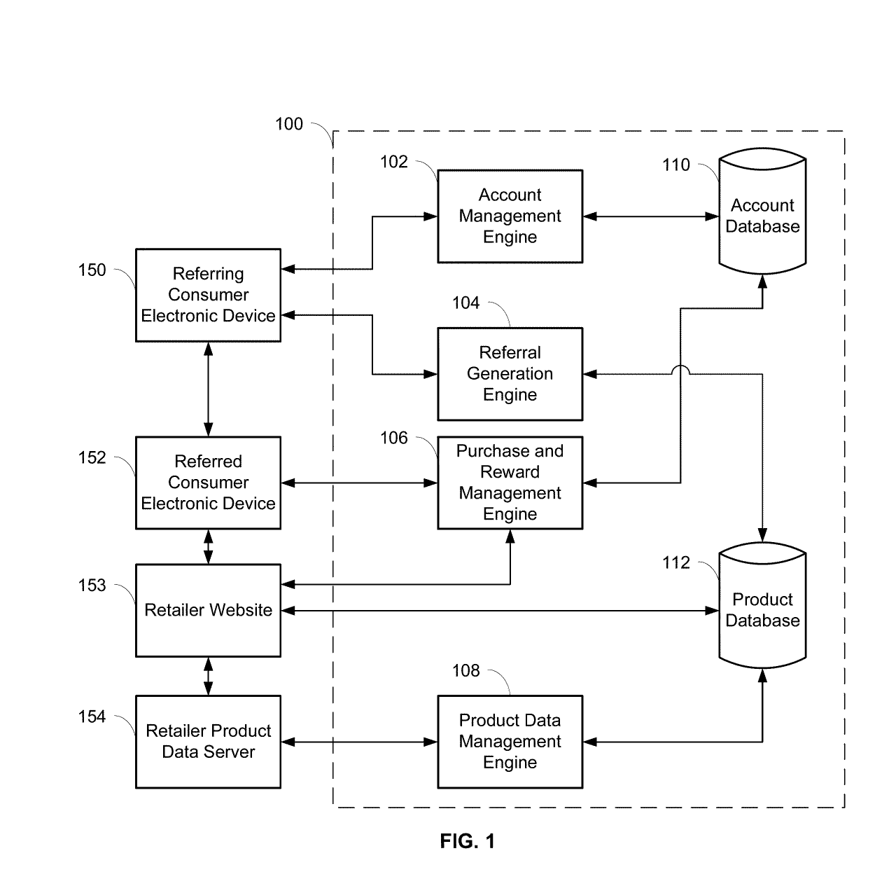

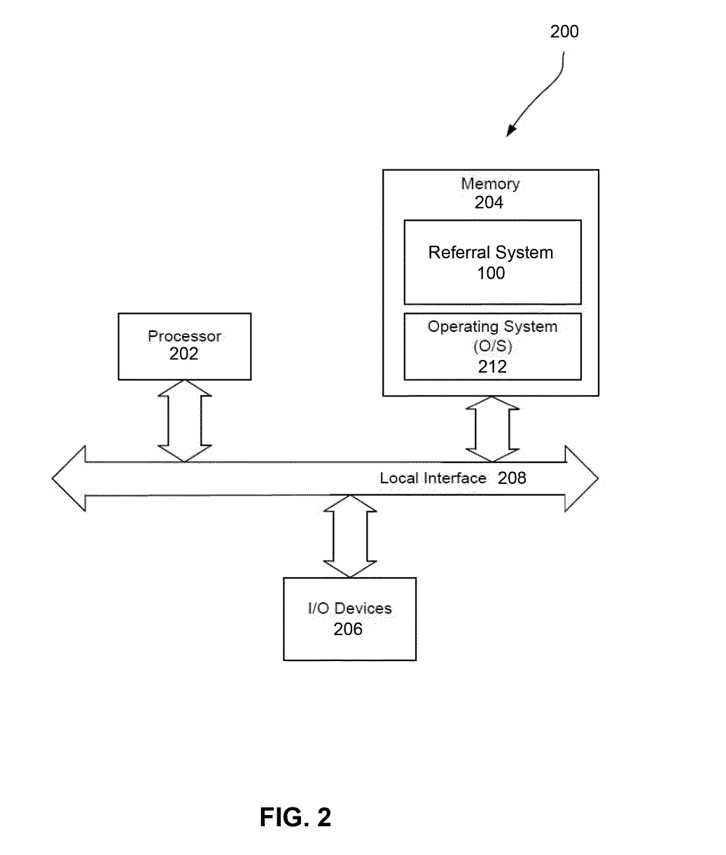

FIG. 1 illustrates a referral system 100 for managing a referral of a referred product, in accordance with one or more principles of the invention. The referral system 100 may provide rewards to an account of a referring consumer in response to accepting a purchase transaction request for a referred product, executing the purchase transaction related to the purchase transaction request, and receiving referring consumer identification data. The purchase transaction request may be received by the referral system 100 from an electronic device 152 associated with a referred consumer (the sales rep device). The referring consumer identification data may have been previously transmitted from the referral system 100 to an electronic device 150 associated with the referring consumer (the target consumer device). The referred consumer electronic device 152 may then have received the referring consumer identification data from the referring consumer electronic device 150. Product data, including product descriptions and images, may be stored in a product database 112 in the referral system 100. Various components of the referral system 100 may be implemented using software executable by one or more servers or computers, such as a computing device 200 with a processor 202 and memory 204 as shown in FIG. 2, which is described in more detail below.

A referring consumer electronic device 150 may communicate with an account management engine 102 and a referral generation engine 104 in the referral system 100. The referring consumer electronic device 150 may be, for example, a Smartphone, a cellular phone, a personal digital assistant, a tablet computer, a laptop computer, or the like. In one embodiment, an application executing on the referring consumer electronic device 150 may facilitate communication with the referral system 100. The application may include a web browser, a specific application for communicating with the referral system 100, or another type of application.

Requests generated by the referring consumer electronic device 150 may be received by the referral generation engine 104. The requests may be for product data relating to one or more products offered by a retailer. The products specified in the requests may include products that the referring consumer has previously purchased from the retailer and/or other products offered by the retailer. The referral generation engine 104 may retrieve the product data from a product database 112, in response to receiving a request. The product data may have been stored in the product database 112 by the product data management engine 108, as described further below. After retrieving the product data from the product database 112, the referral generation engine 104 may transmit the product data to the referring consumer electronic device 150. The product data may include product descriptions, product images, purchase prices, and/or product options (e.g., color, size, optional features, ratings, reviews, etc.).

Product data relating to products available from one or more retailers may be transmitted to the referring consumer electronic device 150. The product data may be stored in the referring consumer electronic device 150 and may be static. For example, the referring consumer electronic device 150 may transmit a request for product data and store the product data. When the referring consumer electronic device 150 accesses the referral system 100 in the future, product data does not necessarily have to be transmitted to the referring consumer electronic device 150 again unless product data relating to other products is desired.

The referring consumer identification data may be included, for example, as a parameter of a uniform resource locator (URL). The URL may be transmitted from the referring consumer electronic device 150 to the referred consumer electronic device 152. When the referring consumer creates an account, as described below, the referring consumer identification data may be generated and transmitted to the referring consumer electronic device 150 from an account management engine 102. The referring consumer identification data that identifies the account of the referring consumer may be embedded in or appended to the URL. Accordingly, when the retailer website 153 corresponding to the URL is visited, such as through a browser on the referred consumer electronic device 152, the retailer website 153 can be informed of the identity of the referring consumer. For example, when a referred consumer visits the retailer website 153 on a browser of the referred consumer electronic device 152, the server for the retailer website 153 can match the identifier in the URL with the identity of the referring consumer. A non-limiting example of the URL includes http://mbsy.co/LUNATIK/10464, with “10464” being the referring consumer identification data. When the referred consumer visits the retailer website 153 on a browser of the referred consumer electronic device 152, tracking data, such as a cookie, may be stored in the browser on the referred consumer electronic device 152 that includes the referring consumer identification data. The tracking data may be interpreted by the referral system 100 and/or the retailer website 153, for example, so that when a purchase transaction request occurs, the referral system 100 and/or the retailer website 153 can determine the identity of the referring consumer. The cookie may be a persistent cookie or a session cookie. In the case where the cookie is a persistent cookie, the referring consumer identification data stored in the cookie can be utilized by the referral system 100 and/or the retailer website 153 for future transactions to determine the identity of the referring consumer. Purchase transaction requests are described in more detail below.

Accounts may be created and managed using the referring consumer electronic device 150 by communicating with the account management engine 102 of the referral system 100. The referring consumer may create an account upon an initial access of the referral system 100 or modify information in an existing account, for example. The account may include a username, a password, a name, an email address, a mailing address, a phone number, or other information from the referring consumer. In one embodiment, prior to creating a new account, the account management engine 102 may also present legal terms and conditions related to usage of the referral system 100 to the referring consumer for approval. The account management engine 102 may store the account and the information in the account in an account database 110. After an account is created, referring consumer identification data may be created that uniquely identifies the referring consumer. The referring consumer identification data may be created by the referral system 100. The account management engine 102 may transmit the referring consumer identification data to the referring consumer electronic device 150, in response to the creation of an account for the referring consumer. In some embodiments, certain operations, such as the creation of the referring consumer identification data, may be performed by one or more servers in a network connected to the referral system 100 and the referring consumer electronic device 150.

A referred consumer electronic device 152 may communicate with a purchase and reward management engine 106 in the referral system 100. The referred consumer electronic device 152 may be, for example, a Smartphone, a cellular phone, a personal digital assistant, a tablet computer, a laptop computer, or the like. In one embodiment, an application executing on the referred consumer electronic device 152 may facilitate communication with the referral system 100. The application may include a web browser, a specific application for communicating with the referral system 100, or another type of application.

The referred consumer electronic device 152 may also communicate with a retailer website 153. The retailer website 153 may be associated with a retailer that does not directly participate in managing and operating the referral system 100 but utilizes the referral system 100 to manage referrals of the retailer's products. The retailer website 153 may be in communication with the purchase and reward management engine 106 and/or the product database 112 in the referral system 100.

Purchase transaction requests generated by the referred consumer electronic device 152 may be received by the purchase and reward management engine 106 and/or the retailer website 153. The purchase transaction requests may be requests to purchase one or more products offered by a retailer, and may include, in particular, a referred product that was recommended by the referring consumer to the referred consumer. The referred product may include a particular product offered by the retailer that the referring consumer has endorsed to the referred consumer. The purchase transaction request may include product information and payment information that allows the referred consumer to purchase the referred product and/or other products. In addition to the purchase transaction request, the referring consumer identification data may also be received from the referred consumer electronic device 152 by the purchase and reward management engine 106. As described above, the referring consumer identification data may uniquely identify the referring consumer. In some embodiments, the purchase transaction request and/or the referred consumer identification data is communicated from the referred consumer electronic device 152 to the purchase and reward management engine 106 via the retailer website 153.

The purchase and reward management engine 106 may accept the purchase transaction request and execute a purchase transaction related to the purchase transaction request by verifying and processing payment information. The validity of the referring consumer identification data may also be verified by the purchase and reward management engine 106, such as by accessing the account database 110 to confirm that an account corresponding to the referring consumer identification data exists. Reward data representing a reward may be provided to an account of the referring consumer in the account database 110 by the purchase and reward management engine 106, in response to accepting the purchase transaction request, executing the purchase transaction related to the purchase transaction request, and receiving the referring consumer identification data from the referred consumer electronic device 152. In particular, the reward data may be provided to the account of the referring consumer after the purchase transaction has been executed, e.g., payment information has been verified and processed, and after the referring consumer identification data has been verified. The reward may include a discount off of a future purchase, a commission based on the price of the referred product, or other type of reward. For example, the reward may include a 10% commission based on the price of the referred product, free products, points towards the purchase of a product, digital currency, specific amounts of money, and/or other rewards.

The reward data and associated reward may be stored and tracked in the account database 110. The referring consumer may view the rewards that have been earned and/or redeem the rewards by accessing their account in the account database 110 through the account management engine 102. A leader board may also be viewed by the referring consumer through the account management engine 102 that may show the amount of rewards earned by the referring consumer as well as the amount of rewards earned by friends, nearby persons, or other people. In the case of commissions, the referring consumer may redeem some or all of the amount earned and receive a check, electronic payment, a credit towards a future purchase, or another form of redemption. In some embodiments, multiple referring consumers, e.g., groups of friends, may consolidate their rewards to enable the purchase of one or more products that the individual consumers could not purchase with their respective rewards.

The purchase and reward management engine 106 may also provide a purchase reward to the referred consumer, in response to receiving the purchase transaction request from the referred consumer electronic device 152. The purchase reward may include a discount off of the concurrent purchase of the referred product or other type of reward. For example, the purchase reward may include a 10% discount off the price of the referred product, free products, points towards the purchase of a product, digital currency, specific amounts of money, and other rewards. In some embodiments, the incentive of a purchase reward for the referred consumer and/or a reward for the referring consumer may expire a set time after the product data is transmitted to the referring consumer electronic device 150. Such a purchase reward provides additional incentive for the referring consumer to use the referral system 100 to make a referral and for the referred consumer to use the referral system 100 to submit a purchase transaction request immediately at the point of referral. In the case when the referring consumer identification data is not verified, e.g., a corresponding account does not exist, the purchase transaction request may be accepted and the purchase transaction related to the purchase transaction request may be executed without issuing a reward to the referring consumer and the referred consumer. In some embodiments, the purchase and reward management engine 106 may provide reward data representing a reward to the referred consumer after execution of the purchase request. Such a reward may include, for example, a discount off of a future purchase of a product or other type of reward.

A product data management engine 108 of the referral system 100 may receive product data relating to one or more products offered by the retailer from a retailer product data server 154. The product data may include product descriptions, product images, purchase prices, and/or product options (e.g., color, size, optional features, ratings, reviews, etc.). The product data may be stored by the product data management engine 108 in the product database 112. As described above, the product data may be utilized by the referral generation engine 104 when a referring consumer electronic device 150 requests product data relating to products offered by the retailer. Product data for some or all of the products offered by the retailer may be stored in the product database 112. The product data in the product database 112 may also be accessed by the retailer website 153.

As an example of the use of the referral system 100, the referring consumer may have accessed a mobile application executing on the referring consumer electronic device 150. The referring consumer may log into their existing account, e.g., entering a username and password, by communicating with the account management engine 102. In this case, referring consumer identification data for uniquely identifying an account of the referring consumer has already been transmitted to the referring consumer electronic device 150. If the referring consumer does not have an account, then an account may be created by the account management engine 102. In this case, the referring consumer identification data may be transmitted to the referring consumer electronic device 150 in response to creating the account.

Product data for one or more products offered by the retailer may be requested by the referring consumer by transmitting a request to the referral generation engine 104. The referral generation engine 104 may retrieve the product data for the requested products from the product database 112 and transmit the product data to the referring consumer electronic device 150. The product data may be browsed and/or searched on the mobile application by the referring consumer and the referred consumer. For example, the referring consumer may show to the referred consumer the product data relating to the referred product and/or other products on the referring consumer electronic device 150. If the referred consumer is interested in the referred product, the referring consumer may enter contact information for the referred consumer into the mobile application so that the product data and the referring consumer identification data are sent to the referred consumer. Other information may also be sent to the referred consumer, such as brand messaging, marketing, advertising, and other information. The contact information may include an email address, a mobile phone number, an instant messaging network username, a social network username, or other contact information.

The product data, the referring consumer identification data, and any other information may be sent to the referred consumer, such as through an email, a text message (e.g., SMS, iMessage, etc.), an instant message (e.g., Skype, Yahoo! Messenger, etc.), a social network message (e.g., Facebook, Twitter, etc.), or other communication medium. In some embodiments, the product data and the referring consumer identification data may travel through one or more servers connected to the referral system 100, the referring consumer electronic device 150, and/or the referred consumer electronic device 152. In other embodiments, the product data and the referring consumer identification data may travel directly from the referring consumer electronic device 150 to the referred consumer electronic device 152, e.g., using Bluetooth, near field communications, etc.

Following receipt of the product data and the referring consumer identification data, the referred consumer may utilize the referred consumer electronic device 152 to view and purchase the referred product. In particular, the referred consumer may visit a website corresponding to the URL included in the referring consumer identification data through a web browser of the referred consumer electronic device 152. The URL may lead to a website 153 of the retailer, for example. Because the URL may include the referring consumer identification data as a parameter, the retailer website 153 may know the identity of the referring consumer. When the referred consumer desires to purchase the referred product, a purchase transaction request may be received from the referred consumer electronic device 152 at the purchase and reward management engine 106. The purchase and reward management engine 106 may accept the purchase transaction request and execute the purchase transaction related to the purchase transaction request, such as by processing payment information from the referred consumer. Accepting the purchase transaction request and executing the purchase transaction may include giving a discount on the purchase of the referred product to the referred consumer. In response to accepting the purchase transaction request and executing the purchase transaction, an account of the referring consumer may be provided with reward data representing a reward, such as a sales commission based on the purchase of the referred product.

FIG. 2 is a block diagram of a computing device 200 housing executable software used to facilitate the referral system 100. One or more instances of the computing device 200 may be utilized to implement any, some, or all of the components in the referral system 100, including the account management engine 102, the referral generation engine 104, the purchase and reward management engine 106, and the product data management engine 108. Computing device 200 includes a memory element 204. Memory element 204 may include a computer readable medium for implementing the referral system 100, and for implementing particular system transactions. Memory element 204 may also be utilized to implement the account database 110 and the product database 112. Computing device 200 also contains executable software, some of which may or may not be unique to the referral system 100.

In some embodiments, the referral system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 200 may be representative of any computer in which the referral system 100 resides or partially resides.

Generally, in terms of hardware architecture as shown in FIG. 2, computing device 200 includes a processor 202, a memory 204, and one or more input and/or output (I/O) devices 206 (or peripherals) that are communicatively coupled via a local interface 208. Local interface 208 may be one or more buses or other wired or wireless connections, as is known in the art. Local interface 208 may have additional elements, which are omitted for simplicity, such as controllers, buffers (caches), drivers, transmitters, and receivers to facilitate external communications with other like or dissimilar computing devices. Further, local interface 208 may include address, control, and/or data connections to enable internal communications among the other computer components.

Processor 202 is a hardware device for executing software, particularly software stored in memory 204. Processor 202 can be any custom made or commercially available processor, such as, for example, a Core series or vPro processor made by Intel Corporation, or a Phenom, Athlon or Sempron processor made by Advanced Micro Devices, Inc. In the case where computing device 200 is a server, the processor may be, for example, a Xeon or Itanium processor from Intel, or an Opteron-series processor from Advanced Micro Devices, Inc. Processor 202 may also represent multiple parallel or distributed processors working in unison.

Memory 204 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 204 can have a distributed architecture where various components are situated remote from one another, but are still accessed by processor 202. These other components may reside on devices located elsewhere on a network or in a cloud arrangement.

The software in memory 204 may include one or more separate programs. The separate programs comprise ordered listings of executable instructions for implementing logical functions. In the example of FIG. 2, the software in memory 204 may include the referral system 100 in accordance with the invention, and a suitable operating system (O/S) 212. Examples of suitable commercially available operating systems 212 are Windows operating systems available from Microsoft Corporation, Mac OS X available from Apple Computer, Inc., a Unix operating system from AT&T, or a Unix-derivative such as BSD or Linux. The operating system O/S 212 will depend on the type of computing device 200. For example, if the computing device 200 is a PDA or handheld computer, the operating system 212 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 212 essentially controls the execution of other computer programs, such as the referral system 100, and provides scheduling, input-output control, file and data management, memory management, and communication control and related services.

If computing device 200 is an IBM PC compatible computer or the like, the software in memory 204 may further include a basic input output system (BIOS). The BIOS is a set of essential software routines that initialize and test hardware at startup, start operating system 212, and support the transfer of data among the hardware devices. The BIOS is stored in ROM so that the BIOS can be executed when computing device 200 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components of the referral system 100 may also be written in a proprietary language developed to interact with these known languages.

I/O device 206 may include input devices such as a keyboard, a mouse, a scanner, a microphone, a touch screen, a bar code reader, or an infra-red reader. It may also include output devices such as a printer, a video display, an audio speaker or headphone port or a projector. I/O device 206 may also comprise devices that communicate with inputs or outputs, such as a short-range transceiver (RFID, Bluetooth, etc.), a telephonic interface, a cellular communication port, a router, or other types of network communication equipment. I/O device 206 may be internal to computing device 200, or may be external and connected wirelessly or via connection cable, such as through a universal serial bus port.

When computing device 200 is in operation, processor 202 is configured to execute software stored within memory 204, to communicate data to and from memory 204, and to generally control operations of computing device 200 pursuant to the software. The referral system 100 and operating system 212, in whole or in part, may be read by processor 202, buffered within processor 202, and then executed.

In the context of this document, a “computer-readable medium” may be any means that can store, communicate, propagate, or transport data objects for use by or in connection with the referral system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The referral system 100 can be embodied in any type of computer-readable medium for use by or in connection with an instruction execution system or apparatus, such as a computer.

For purposes of connecting to other computing devices, computing device 200 is equipped with network communication equipment and circuitry. In an embodiment, the network communication equipment includes a network card such as an Ethernet card, or a wireless connection card. In a network environment, each of the plurality of computing devices 200 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while an embodiment of the invention is for each computing device 200 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

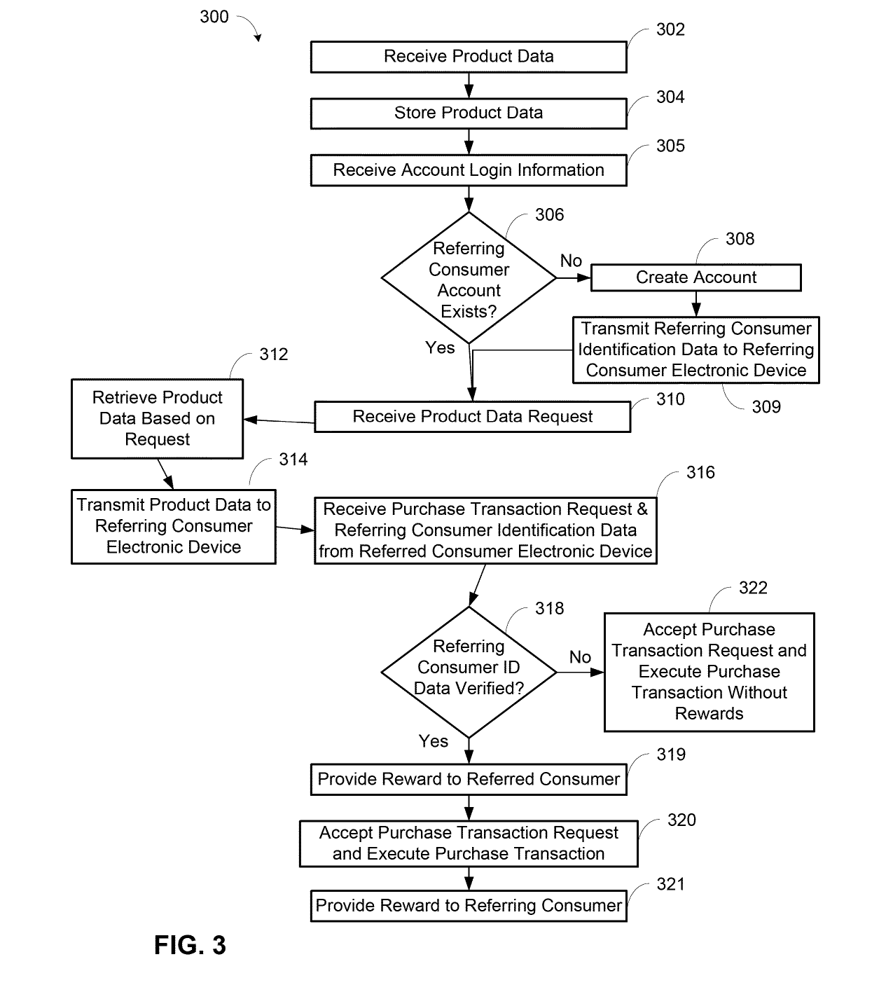

FIG. 3 is a flowchart of a method 300 for managing a referral for a referred product, in accordance with one or more principles of the invention. The method 300 may result in providing reward data representing rewards to an account of a referring consumer in response to accepting a purchase transaction request for a referred product, executing a purchase transaction related to the purchase transaction request, and receiving referring consumer identification data. At step 302, product data for one or more products offered by one or more retailers may be received, such as from a retailer product data server 154. The product data may include, for example, product descriptions, product images, purchase prices, and/or product options. The product data may be stored at step 304 in a product database, such as the product database 112.

At step 305, account login information may be received from a referring consumer, such as from a referring consumer electronic device 150. It may be determined at step 306 whether an account corresponding to the referring consumer exists. If an account corresponding to the referring consumer does not exist, then at step 308, the referring consumer may create an account by providing account information, such as a username, a password, a name, an email address, a mailing address, a phone number, or other information. Referring consumer identification data that uniquely identifies the account of the referring consumer may be created when the account is created at step 308. The referring consumer identification data may be transmitted to the referring consumer electronic device 150 at step 309, and the method 300 may continue to step 310.

The method 300 may also continue to step 310 if an account corresponding to the referring consumer exists at step 306. At step 310, a product data request may be received from the referring consumer electronic device 150. The request may be directed to product data relating to one or more products offered by the retailer(s). The product(s) specified in the request may include products that the referring consumer has previously purchased from the retailer(s) and/or other products offered by the retailer(s). The product data relating to the product(s) specified in the request may be retrieved from the product database 112 at step 312. The product data may have been previously stored in the product database 112 at step 304, as described above. The retrieved product data may be transmitted at step 314 to the referring consumer electronic device 150.

A purchase transaction request and the referring consumer identification data may be received at step 316 from a referred consumer electronic device 152. For example, the referred consumer electronic device 152 may have visited a website corresponding to the URL, and the URL may have a parameter including the referring consumer identification data. The referring consumer identification data may be stored as a cookie on the referred consumer electronic device 152, as a result of visiting the website corresponding to the URL. The purchase transaction request may be a request to purchase one or more products offered by one or more retailers, and may include, in particular, a referred product that was recommended by the referring consumer to the referred consumer. The referred product may include a particular product offered by the retailer that the referring consumer recommended to the referred consumer. The purchase transaction request may also include product information and payment information that allows the referred consumer to purchase the referred product and/or other products. The referred consumer electronic device 152 may have received the referring consumer identification data from the referring consumer electronic device 150.

The referring consumer identification data may be verified at step 318 to ensure that a referring consumer exists and is uniquely identified. For example, the referring consumer identification data may be compared to existing accounts in the account database 110 to ensure its validity. If the referring consumer identification data is not verified at step 318, then the purchase transaction request may be accepted and a purchase transaction related to the purchase transaction request may be executed at step 322 without providing a reward to the referring consumer or a purchase reward to the referred consumer. In some embodiments, when referring consumer identification data is not verified, an error may be transmitted that specifies that the account of the referring consumer does not exist and that the purchase transaction request for the referred consumer cannot be accepted. Referring consumer identification data may not be verified at step 318 if, for example, an account corresponding to the referring consumer identification data does not exist in the account database 110. In other embodiments, any fraudulent activity related to the referring consumer identification data may be checked at step 318, such as identifying unusual purchase amounts or other possibly fraudulent activity. In this case, the referring consumer identification data may not be verified at step 318 if fraudulent activity is identified.

If the referring consumer identification data is verified at step 318, then a purchase reward may be provided to the referred consumer at step 319, such as a discount off of the purchase of the referred product or another type of reward. At step 320, the purchase transaction request may be accepted, and a purchase transaction related to the purchase transaction request may be executed which includes the purchase reward provided at step 319. Step 320 may include verifying and processing the payment information to execute the purchase transaction. At step 321, reward data representing a reward may be provided to an account of the referring consumer, in response to executing the purchase transaction. The reward may include a discount off of a future purchase, a commission based on the price of the referred product, or other type of reward. In some embodiments, reward data representing a reward may be provided to the referred consumer following step 320, such as for a discount off of a future purchase or other type of reward.

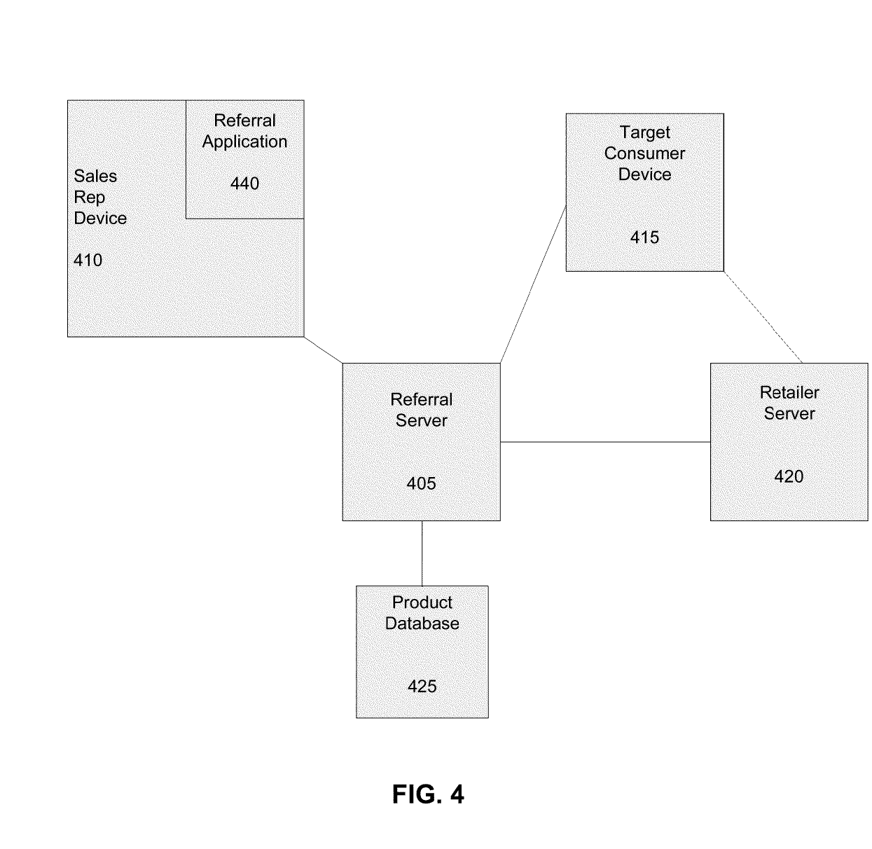

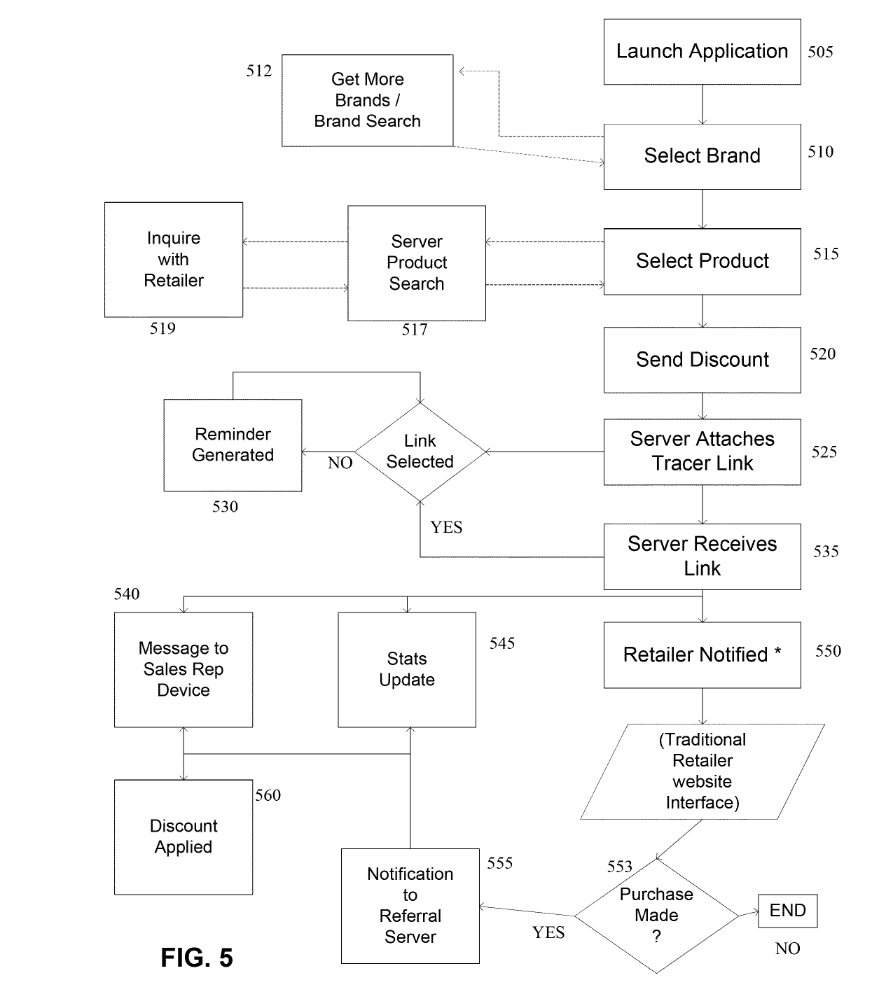

FIGS. 4 and 5 are directed to another embodiment of the referral system. In this case, as shown in FIG. 4, all traffic is routed through a central referral server 405. Connected the referral server 405 are a sales rep (referrer) device 410, a target consumer device 415, a retailer server 420, and a product database 425. By routing all communication through the referral server 405, the system is aware of all steps being taken by the sales rep, the target consumer and retailer with respect to a purchase of a referred product. The flow of information is best reviewed in association with FIG. 5, which walks through a typical scenario of a system use.

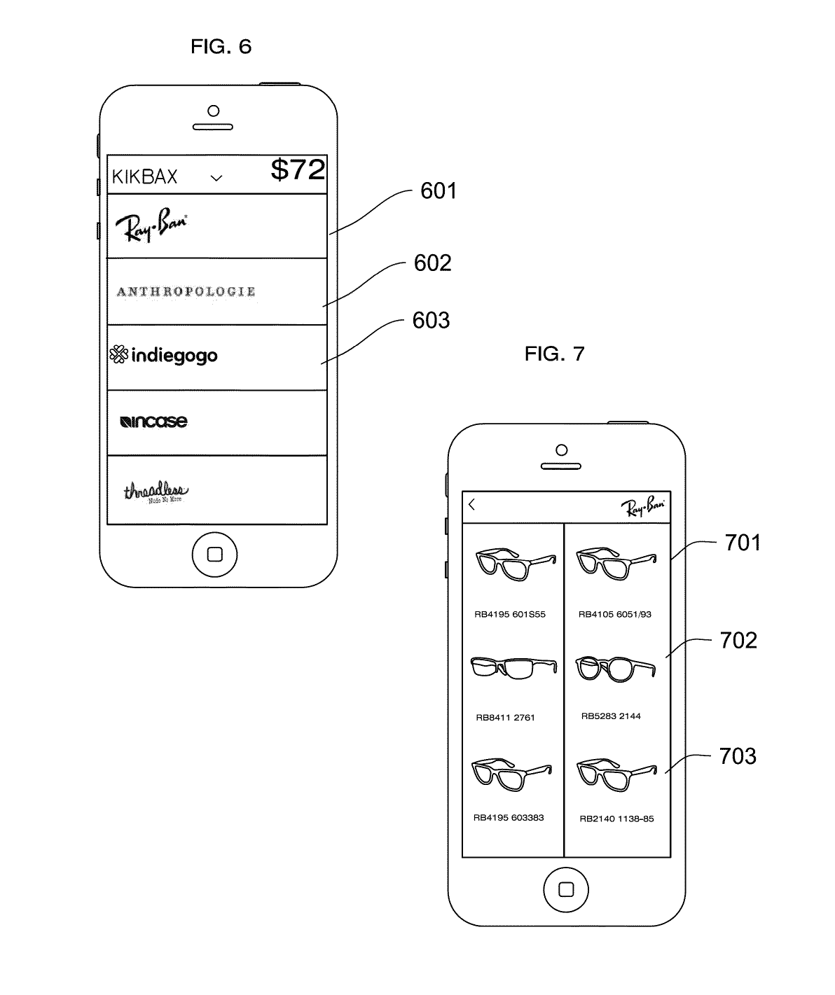

The process initiates in FIG. 5, for example, where a prospective customer has expressed an interest in or otherwise inquired about a product owned by an existing customer. Both the prospective customer (the target consumer) and the existing customer (the sales rep) have smart phones, and the sales rep has downloaded a referral application 440 from the referral system 405 to facilitate the referral process. At step 505, the sales rep launches the referral application 440 on her sales rep device (such as, for example, an iPhone). The referral application 440 shows a list of potential brands available to choose from, such as shown in the exemplary screen shot of FIG. 6, where brands 601, 602 and 603 appear.

If the brand of interest is available, the sales rep selects it at step 510. If not, a call may be made from the sales rep device 410 to the referral server 405 to query whether other brands are available, as shown in optional step 512. Whether a brand is available will depend on whether the retailer associated with that brand has joined the referral system and agreed to certain terms and conditions relating to discounts and electronic communication tracking Certain brands may be associated with the initial download of the referral application 440. A sales rep may then customize the application by selecting “favorite” brands that will show up on the launch screen, according to certain embodiments. If a new brand is added to the referral system, data and products associated with that brand are made available for download through the referral server 405.

Once a brand is selected (such as, for example, by pressing the brand on the screen of the sales rep device 410), a list of products upon which referral discounts are available populates. As shown in the exemplary application 440 screen of FIG. 7, where products 701, 702 and 703 appear. A sales rep then scrolls through the available products within the brand and selects the product of interest at step 515. In cases where the target consumer is physically present, this allows the target consumer to participate in the product selection. For example, it may be that the target consumer prefers a different variety of product than the one that initially peaked his interest.

In cases where the product of interest cannot be located on the screen, or there is a desire to see more product from the retailer, a call (e.g., a data request transmission) may be made to the referral server 405 (optional step 517) to request any additional products available for that brand. In this manner, the application 440 on the sales rep device 410 need not be constantly updated, but updates as to product discount availability may be housed at the server 405 level, or on the product database 425. In some cases, an additional call can be made to the retailer server 420 (step 519) to be sure the latest updates are available.

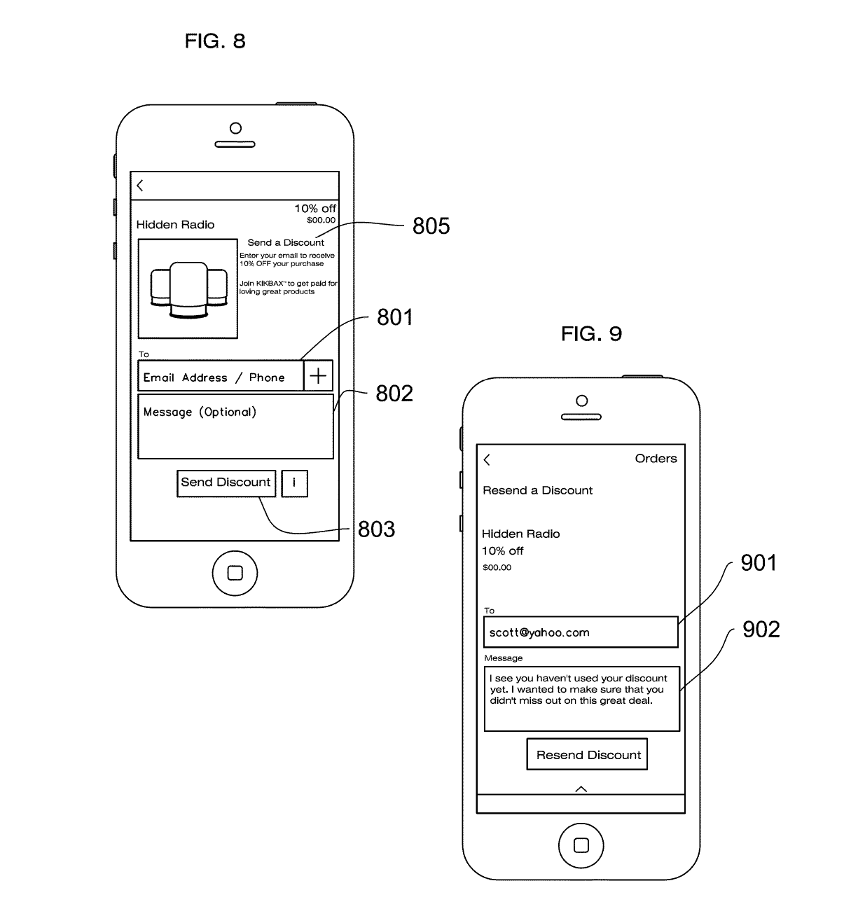

Once the product is selected, the application 400 provides the ability to generate and send a discount to the target consumer at step 520. An exemplary screen for this activity is shown in FIG. 8. As shown, the selected product and associated discount are displayed in a product display area 805 that provides information and a visual image of the product. Contact box 801 receives the email address (or SMS capable cell number, etc.) of the target customer, and an area for an optional message 802 is also included. Once this information is entered, the Send Discount button 803 is selected.

The application 400 routes the message to the referral server 405, which identifies the sales rep based on information contained within the transmission and attaches a tracer link (referring consumer ID data) to the message at step 525. It then forwards then link on to the target consumer device 415 based on the contact data submitted by the sales rep. Once received by the target consumer, the system pauses until the link from the referral server 405 is selected. Because all traffic is routed through referral server 405, the server will receive notice when the target consumer selects the link. If this is not done within a given amount of time, the referral server 405 will send a message to the referral application 440 on the sales rep device 410 asking whether a reminder should be send. An example of such a reminder can be seen at FIG. 9. As shown, the screen pre-loads the target contact information in box 901 and a sample message in 902. The message may then be tailored or sent by the sales rep at step 530. The reminder is then forwarded to the target consumer device 415 via the referral server 405. In some embodiments, the message may include a deadline by which the link must be selected or the offer will expire. In other embodiments, the sales rep can send additional reminders. However, the referral system will track this (again, by virtue of all communication passing through the referral server 405) and may recommend that additional reminders not be sent to avoid a negative impression on the target consumer.

If the target consumer eventually selects the link, it will cause the target consumer device 415 to send a message back through referral server 405. Note that no component of application 440 needs to reside on target consumer device 415. Rather, its role can be performed via whatever communication software the target consumer uses to receive messages, such as a text message or email application. At step 535, the server receives the link selection from the target consumer device 415 and interprets from the link that a specific product has been requested from a specific retailer, which was referred from a specific sales rep. At this point, the server 405 sends a message to the application 440 on the sales rep device 410 advising the sales rep of the link selection (step 540) and also updates stats relating to the sales reps's system activity and referrals (step 545). These stats are discussed further below, and may be housed on the server 405, within the memory of the sales rep device associated with the application 440, or both.

Simultaneously, the referral server 405 will send the link along to the retailer server 420 associated with the selected product. Again, this would be a retailer already enrolled in the referral system. At step 550, the retailer server 420 would then send website data to the target consumer device 415 (again, via referral server 405) that would cause a browser window on the device 415 to launch an HTML page associated with the retailer. From this point, the target consumer could interact with the retailer website through traditional means (note the dashed line connecting target consumer device 415 directly to retailer server 420 on FIG. 4), with the exception that the retailer recognizes a discount code associated with the transaction. If no purchase is made, the process ends. However, if a purchase is made, the retailer server 420 sends a discount redemption notification to the referral server 405, which identifies to the server 405 that a purchase resulted from the referral link. In this case, at step 555, the referral server 405 credits the sales rep with any reward due based on the referral. It also proceeds to notify the sales rep via a transmission to sales rep device 410 and updates the stats for the sales rep in the manner described above in association with steps 540 and 545.

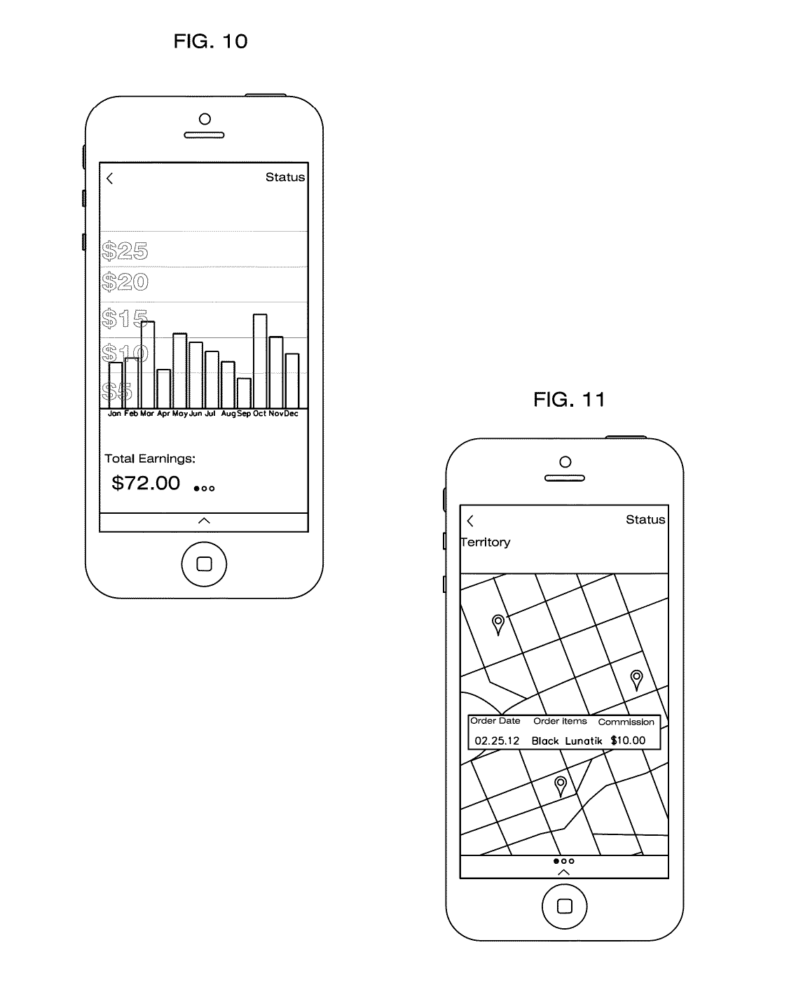

FIGS. 10 and 11 show exemplary statistical tracking data available to sales reps through the referral system, according to some embodiments. As shown in Fig., rewards based on referrals are laid out temporally. In FIG. 11, a map is displayed showing where referrals were made. Each referral is identified by an icon that may be selected to reveal specific information about the referral, such as that shown. Other stat layouts show referrals by time of day, product type, and brand. This information can be cross-referenced with the outcome of the referral (e.g., was the link ever selected, was a reminder sent, was a purchase made, etc.). Using this information, the sales rep can learn what works and what does not, and adjust tactics accordingly.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method of managing a referral for a referred product, wherein the referred product is one of a plurality of products offered by a retailer, the method comprising:
transmitting referring consumer identification data from a processor to a first electronic device associated with a referring consumer, wherein the referring consumer identification data is for uniquely identifying an account of the referring consumer;
receiving a request at the processor from the first electronic device, wherein the request is for product data relating to the referred product;
receiving to the processor the product data relating to the referred product from a database, in response to receiving the request;
transmitting the product data relating to the referred product from the processor to the first electronic device;
generating, at the processor, a unique data string for use in tracking a referral link through a transaction process, wherein the unique data string identifies at least the referring consumer, and the referred product;
receiving to the processor a purchase transaction request for the referred product from a second electronic device associated with a referred consumer, wherein the request includes the unique data string;
accepting the purchase transaction request for the referred product and executing a purchase transaction related to the purchase transaction request, using the processor; and
using the processor, providing reward data representing a reward to the account of the referring consumer in response to accepting the purchase transaction request and executing the purchase transaction, wherein the reward is based on the purchase transaction request for the referred product and the account is identified from the referring consumer identification data.

2. The method of claim 1, wherein receiving the referring consumer identification data from the second electronic device comprises receiving the referring consumer identification data as a parameter of a uniform resource locator.

3. The method of claim 2, wherein the purchase transaction request is received to the processor by way of the uniform resource locator including the referring consumer identification data provided to the second electronic device by the first electronic device.

4. The method of claim 1, further comprising providing a purchase reward to the referred consumer in response to receiving the purchase transaction request, using the processor, based on the purchase transaction request for the referred product.

5. The method of claim 4, wherein:
the purchase reward comprises a discount off of a purchase price of the referred product; and
accepting the purchase transaction request comprises including the discount off of the purchase price of the referred product.

6. The method of claim 1, further comprising:
creating the account of the referring consumer using the processor, wherein the account comprises one or more of a username, a password, a name, an email address, a mailing address, or a phone number of the referring consumer; and
creating the referring consumer identification data for uniquely identifying the account of the referring consumer, in response to creating the account of the referring consumer.

7. The method of claim 1, wherein the referred product has been previously purchased by the referring consumer.

8. A system for managing a referral for a referred product, wherein the referred product is one of a plurality of products offered by a retailer, the system comprising:
a processor in communication with a network;
a memory in communication with the processor, the memory for storing:
a product database comprising product data relating to the referred product;
an account management engine for transmitting referring consumer identification data to a first electronic device associated with a referring consumer, wherein the referring consumer identification data is for uniquely identifying an account of the referring consumer;
a referral generation engine for:
receiving a request from the first electronic device, wherein the request is for the product data relating to the referred product;
retrieving the product data relating to the referred product from the product database, in response to receiving the request;
transmitting the product data relating to the referred product to the first electronic device; and
appending the referring consumer identification data to the referral; a purchase and reward management engine for:
receiving a purchase transaction request for the referred product and the referring consumer identification data from a second electronic device associated with a referred consumer;
accepting the purchase transaction request for the referred product and executing a purchase transaction related to the purchase transaction request; and
providing reward data representing a reward to the account of the referring consumer in response to accepting the purchase transaction request and executing the purchase transaction, wherein the reward is based on the purchase transaction request for the referred product and the account is identified from the referring consumer identification data.

9. The system of claim 8, wherein the purchase and reward management engine receives the referring consumer identification data by receiving the referring consumer identification data as a parameter of a uniform resource locator.

10. The system of claim 9, wherein the purchase and reward management engine is for receiving the purchase transaction request by way of the uniform resource locator including the referring consumer identification data provided to the second electronic device by the first electronic device.

11. The system of claim 8, wherein the purchase and reward management engine is further for providing a purchase reward to the referred consumer in response to receiving the purchase transaction request, based on the purchase transaction request for the referred product.

12. The system of claim 11, wherein:
the purchase reward comprises a discount off of a purchase price of the referred product; and
the purchase and reward management engine accepts the purchase transaction request by including the discount off of the purchase price of the referred product.

13. The system of claim 8, wherein the account management engine is further for:
creating the account of the referring consumer, the account comprising one or more of a username, a password, a name, an email address, a mailing address, or a phone number of the referring consumer; and
creating the referring consumer identification data for uniquely identifying the account of the referring consumer, in response to creating the account of the referring consumer.

14. The system of claim 8, wherein the referred product has been previously purchased by the referring consumer.

15. A referral generation system for use by a sales rep comprising:
a sales rep device housing a referral application linked to a memory for storing brand info and product info, wherein the application utilizes a display associated with the sales rep device to facilitate selection of a first product and entry of target contact data;
a target consumer device associated with the target contact data for receiving a link containing at least:
data for use in accessing a retailer website through which the first product may be purchased;
data for use in identifying a discount associated with the product wherein the discount only applies if the product is purchased from the retailer website when accessed using the link; and
data for use in rewarding the sales rep in the event that the discount is applied; and
a referral server for generating the link in response to receipt of product info and target contact data from the sales rep device.

16. The system of claim 15, wherein the link generated by the referral server also contains data uniquely identifying the sales rep.

17. The system of claim 15, further comprising a retailer server for providing retailer website data to the target consumer device in response to a selection of the link.

18. The system of claim 16, wherein the retailer server provides a discount redemption notification to the referral server, and wherein such notification contains the data uniquely identifying the sales rep.
